(19) United States
(12) Patent Application Publication
(10) Pub. No.: US 2017/0074167 A1
(43) Pub. Date: Mar. 16, 2017

(54) TURBOFAN ENGINE MOUNTED PRECOOLER SYSTEM

(71) Applicant: HONEYWELL INTERNATIONAL INC., Morristown, NJ (US)

(72) Inventors: Shawn Alstad, Peoria, AZ (US); Robert Romano, Tempe, AZ (US); Morris Anderson, Mesa, AZ (US); Robert Hoover, Phoenix, AZ (US)

(73) Assignee: HONEYWELL INTERNATIONAL INC., Morristown, NJ (US)

(21) Appl. No.: 14/850,300

(22) Filed: Sep. 10, 2015

(51) Int. Cl. F02C 7/18

(52) U.S. Cl. CPC F02C 7/185

(57) ABSTRACT

A precooler system having a symmetrical precooler core that is optimized to be integrally mounted to the turbofan engine, regardless of the turbofan engine size, is provided. The provided precooler system optimizes available space between a turbofan engine and the nacelle, and does not substantially increase weight and cost. The provided precooler system may be flexibly implemented as either a right handed precooler system or a left handed precooler system.

### TECHNICAL FIELD

The present invention relates to a precooler system for use with a turbofan engine, and more particularly to a turbofan engine mounted precooler system.

### BACKGROUND

Turbofan engines are often configured to divert a portion of high-energy compressed air (generally from a compressor section of the turbofan engine) for use in other aircraft systems. The diverted compressed engine air may be supplied to aircraft systems, such as an aircraft environmental control system (ECS), an aircraft anti-ice system, and the like. To minimize the chance of fires due to hot surface ignition within the fuselage of the aircraft, the high temperature compressor bleed air is cooled by lower temperature fan bleed air. The diverted air is typically cooled by a precooler or heat exchanger (referred to herein as a precooler) prior to its introduction to the fuselage in aircraft with fuselage mounted engines. However, determining where to locate the precooler with respect to the turbofan engine in these installations is not straightforward.

Locating a precooler proximate a turbofan engine is desirable but traditionally untenable. Turbofan engines are generally surrounded by a nacelle that provides a smooth outer cover, and creates a bounded space within which the turbofan engine operates. In traditional turbofan engine designs, the space between the turbofan engine and the nacelle is limited and generally consumed by other turbofan engine systems. Consequently, in all but the largest of turbofan engines, space and weight considerations often drive the disposition of the precooler to locations remote from the turbofan engine, such as within the pylon. Additional ducting and components may then then be required for routing the engine air to and from the precooler. However, the additional ducting and components may add weight and cost to the aircraft, a generally undesirable result as the demand for more economical aircraft continues to increase. Additionally, disposing of the precooler in the pylon requires the precooler system to have separate right hand and left hand permutations, and prohibits that pylon space to be used for other aircraft systems and devices. The separate left hand and right hand precooler system increases part count, and part cost.

Hence, there is a need for a non-handed precooler system having a symmetric precooler core that is optimized to be integrally mounted to the turbofan engine, regardless of the turbofan engine size. The desired precooler system optimizes available space between a turbofan engine and the nacelle, and does not substantially increase weight and cost. The present invention provides these features.

### BRIEF SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

A precooler system is provided. The precooler system comprising:

a nacelle;

a turbofan engine housed within the nacelle, the turbofan engine configured to discharge engine air and bypass air; the turbofan engine comprising a bypass duct providing a path for the bypass air;

a high pressure shut off valve (HPSOV) coupled to the turbofan engine;

a pressure regulating shut off valve (PRSOV) coupled to the turbofan engine and to the HPSOV; wherein the HPSOV and PRSOV are each (i) located within the same turbofan engine stage, and (ii) configured to cooperatively regulate pressure of engine air; and a symmetrical precooler core disposed outside of the bypass duct, integrally mounted in an opening in the nacelle, and forming a substantially continuous outer wall of the bypass duct, the symmetrical precooler core comprising (i) a first flow passage having an engine air inlet and an engine air outlet, the first flow passage being in flow communication with engine air at the engine air inlet and discharge air at the engine air outlet, and (ii) a second flow passage having bypass flow path inlet and a bypass flow path outlet and being in flow communication with bypass air at the bypass flow path inlet and ambient air at the bypass flow path outlet.

Another precooler system is provided. The precooler system comprising:

a turbofan engine configured to discharge engine air and bypass air, the turbofan engine having a bypass duct associated therewith; and

a symmetrical precooler core configured to be integrally mounted in an opening in a nacelle, and disposed outside of the bypass duct, the symmetrical precooler core comprising
(i) a first flow passage having an engine air inlet and an engine air outlet, the first flow passage being in flow communication with the engine air at the engine air inlet and with discharge air at the engine air outlet, and
(ii) a second flow passage having bypass flow path inlet and a bypass flow path outlet and being in flow communication with bypass air at the bypass flow path inlet and ambient air at the bypass flow path outlet,

the symmetrical precooler core further configured to transfer heat between the first flow passage and the second flow passage.

Also provided is a symmetrical precooler core, the symmetrical precooler core comprising:

a first flow passage having an engine air inlet and an engine air outlet, the first flow passage configured to be in flow communication with engine air at the engine air inlet and with discharge air at the engine air outlet; and

a second flow passage having bypass flow path inlet and a bypass flow path outlet and configured to be in flow communication with bypass air at the bypass flow path inlet and with ambient air at the bypass flow path outlet; and

wherein the symmetrical precooler core is configured to (i) be disposed outside of a turbofan engine bypass duct, (ii) be integrally mounted in an opening in a nacelle, (iii) form a substantially continuous outer wall of the bypass duct.

Other desirable features will become apparent from the following detailed description and the appended claims, taken in conjunction with the accompanying drawings and this background.

### BRIEF DESCRIPTION OF THE DRAWINGS

A more complete understanding of the subject matter may be derived by referring to the following Detailed Description and Claims when considered in conjunction with the following figures, wherein like reference numerals refer to similar elements throughout the figures, and wherein:

FIG. 1 is a simplified illustration of a traditional turbofan engine having a precooler located within the pylon;

FIG. 2 is a simplified cross-sectional side view of a turbofan engine showing a precooler system, in accordance with an exemplary embodiment;

FIG. 3 is a partial cross sectional view, above a turbofan engine centerline, showing a key features of a precooler system, in accordance with an exemplary embodiment;

FIG. 4 is a three dimensional image of key features of a precooler system in accordance with an exemplary embodiment;

FIG. 5 is an illustration of the precooler of FIG. 4 showing of the air path getting through the precooler cross tubes, in accordance with an exemplary embodiment;

FIG. 6 is a three dimensional image of a support structure in accordance with an exemplary embodiment;

FIG. 7 is a partial cross sectional view of a precooler system showing a support structure and arrangement of cross tubes, in accordance with the exemplary embodiment;

FIG. 8 and FIG. 9 are three dimensional images showing a precooler core with a blocking assembly on a bypass duct side of the precooler core, in accordance with an exemplary embodiment; and

FIG. 10 and FIG. 11 are three dimensional images showing the precooler core utilized in a right handed and in a left handed application, respectively, in accordance with an exemplary embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments.

Although not the focus of the present invention, one with skill in the art will readily appreciate that the traditional turbofan engine comprises multiple sections, in stages. For easy reference in the below detailed description, a simplified description of a traditional turbofan engine with a cooling system is provided as follows.

A traditional turbofan engine is generally enclosed within a nacelle and comprises a fan section, a compressor section, a combustion section, a turbine section, and an exhaust section. The compressor section raises the pressure and increases the temperature of the air directed into it from the fan section. The compressor section may direct the compressed air into the combustion section. In the combustion section, the high pressure air is mixed with fuel and combusted. The combusted air is then directed into the turbine section, wherein it expands through turbines, causing them to rotate, and is then exhausted through a mixer nozzle and combines with air from a bypass duct. At least some compressed air is generally reserved for the aircraft. This is known as customer bleed air. It is generally high pressure and high temperature air that comes from the engine and is sent via ducting to the airframe.

The installation of a traditional turbofan engine in a modern aircraft requires the high pressure compressor discharge air to be cooled prior to its introduction to other sections of the aircraft. In this regard, a cooling system typically includes a precooler. Prior to being sent to the precooler, the high pressure compressor discharge air is generally pressure regulated via several valves and associated ducting. Two of these valves include the high pressure shut off valve (HPSOV) and the pressure regulating shut off valve (PRSOV). The HPSOV selects the compressor stage from which the high pressure air source is retrieved. The PRSOV is generally used to control or modulate the quantity of engine air pressure flow in the ducting being supplied to other aircraft systems.

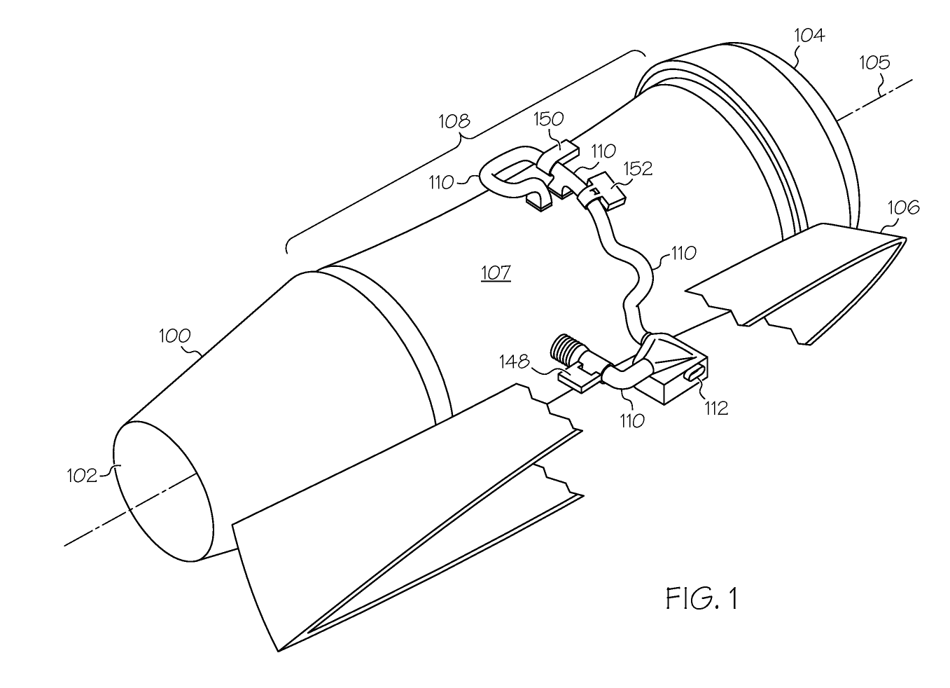

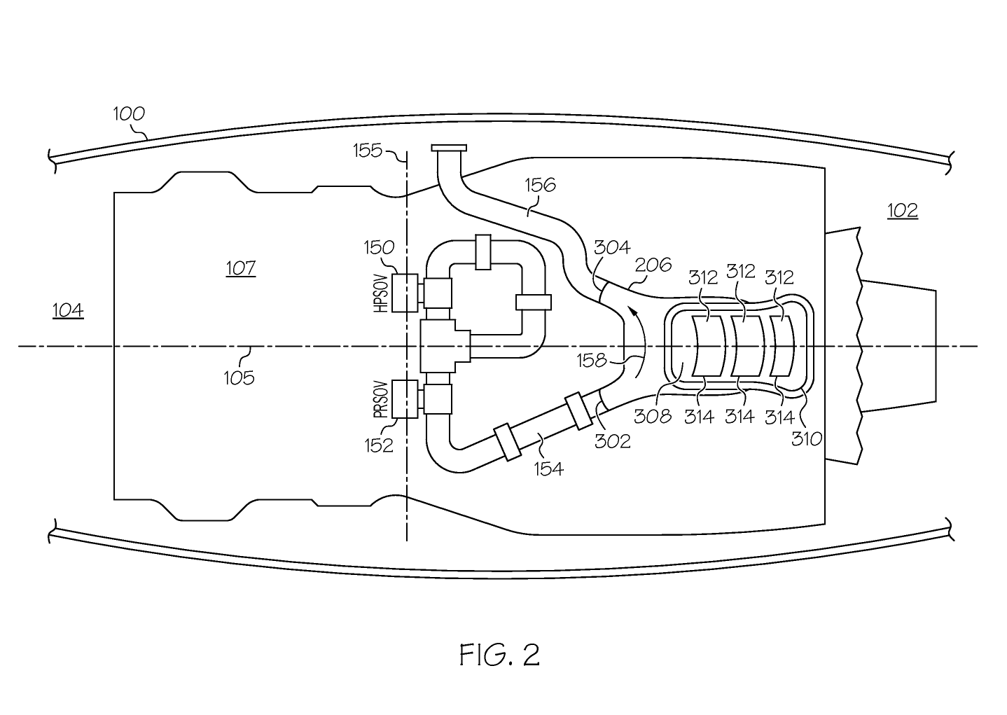

Together, the HPSOV and PRSOV are configured to cooperatively regulate the pressure of the high pressure, high temperature compressor discharge air subsequently received by the precooler. Accordingly, in some applications, the orientation and location of the HPSOV and PRSOV, with respect to the precooler, are design specific features of a precooler system. FIG. 1 is a simplified illustration of a traditional precooler system for a turbofan engine and FIGS. 2-11 present a novel precooler core for a turbofan engine mounted precooler system.

The precooler receives low pressure, low temperature fan discharge air from the engine. This air is used to cool the high pressure, high temperature compressor discharge air to be delivered to other aircraft subsystems located in the fuselage of the aircraft. After passing through the precooler, the low pressure air is discharged overboard. However, the fan discharge airflow is regulated by a fan air valve (FAV). The fan air valve is a modulating flow control system used to minimize the amount of fan air discharged overboard. FIG. 1 shows the location of the fan air valve in a traditional precooler system.

FIG. 1 is a simplified, cross-sectional view of a nacelle 100 having an airflow inlet at the forward side 104 and an exhaust nozzle at the aft side 102. Turbofan engine centerline 105 is shown. Nacelle 100 has a portion 108 removed to reveal an enclosed turbofan engine 107. Ducting 110 couples the turbofan engine to a precooler 112. As previously mentioned, the precooler 112 typically does not fit within available space between the nacelle 100 and the turbofan engine 107, and is therefore generally placed within a pylon 106, outside of the nacelle 100. The fan air valve 148 is generally placed within the pylon, outside of the nacelle.

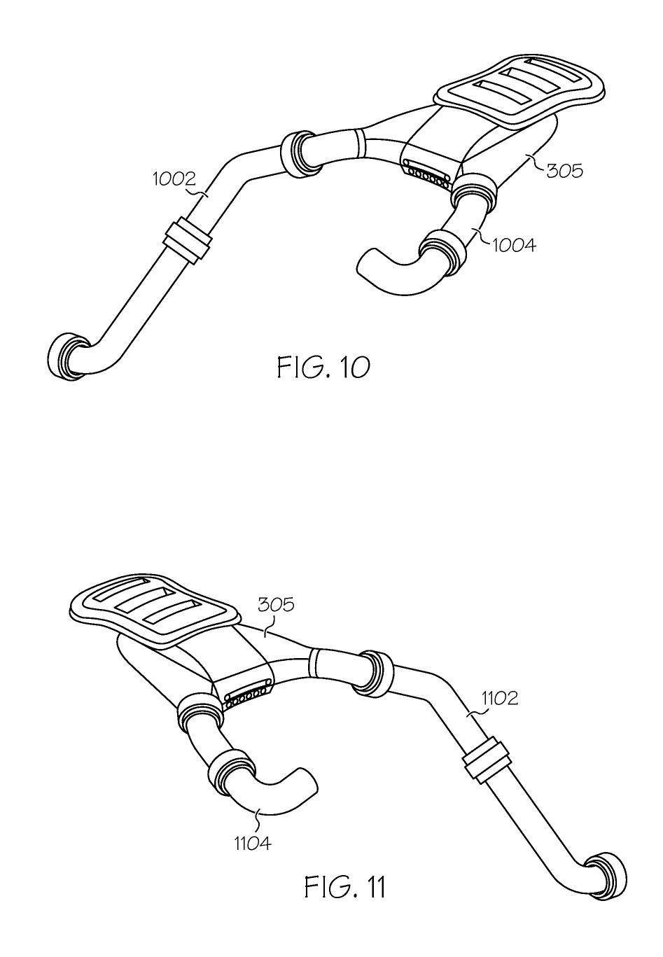

FIG. 2 is a simplified plan view of a turbofan engine showing a precooler system, in accordance with an exemplary embodiment. The provided precooler system 206 optimizes space between the turbofan engine 107 and the nacelle 100. “Stage” 155 represents a volumetric space wherein the turbofan engine 107 has the smallest diameter. Accordingly, at stage 155, the volumetric space between the turbofan engine 107 and the nacelle 100 is the largest. In this embodiment, HPSOV 150 and PRSOV 152 are located substantially within turbofan engine stage 155, thereby optimizing available space. Ducting 154 provides engine air to precooler system 206, and ducting 156 channels discharge air released from precooler system 206 to a target aircraft system (not shown). The implementation of precooler system 206 depicted in FIG. 2 may be referred to as a left handed implementation. The novel precooler core proposed herein is non-handed, in that it may be implemented in either direction (for comparison, refer to FIGS. 10-11).

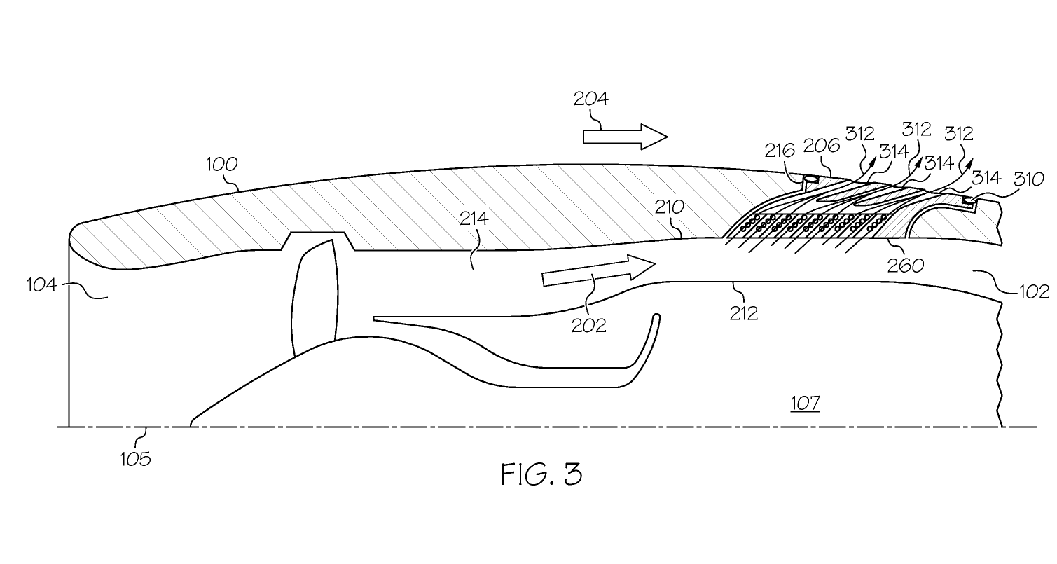

The precooler system 206 provides a first flow passage 158 being in flow communication with pressure regulated engine air at an engine air inlet 302 and discharge air at an engine air outlet 304. The precooler system 206 also provides one or more second flow passages 312 having a bypass flow path inlet (FIG. 3, 260) and one or more bypass flow path outlets 314. The second flow passage 312 being in flow communication with bypass air (FIG. 3 202) at the bypass flow path inlet and ambient air at the bypass flow path outlet.

Once through the HPSOV, PRSOV, and associated ducting, the high temperature, compressed, engine air is sufficiently pressure regulated for the precooler at engine air inlet 302. In an embodiment, an engine air supply duct 154 supplies compressed, high temperature engine air to the precooler system 206. Although shown as a pipe, the engine air supply duct 154 and duct 156 may alternatively be any structure suitable for delivering air to the precooler system 206.

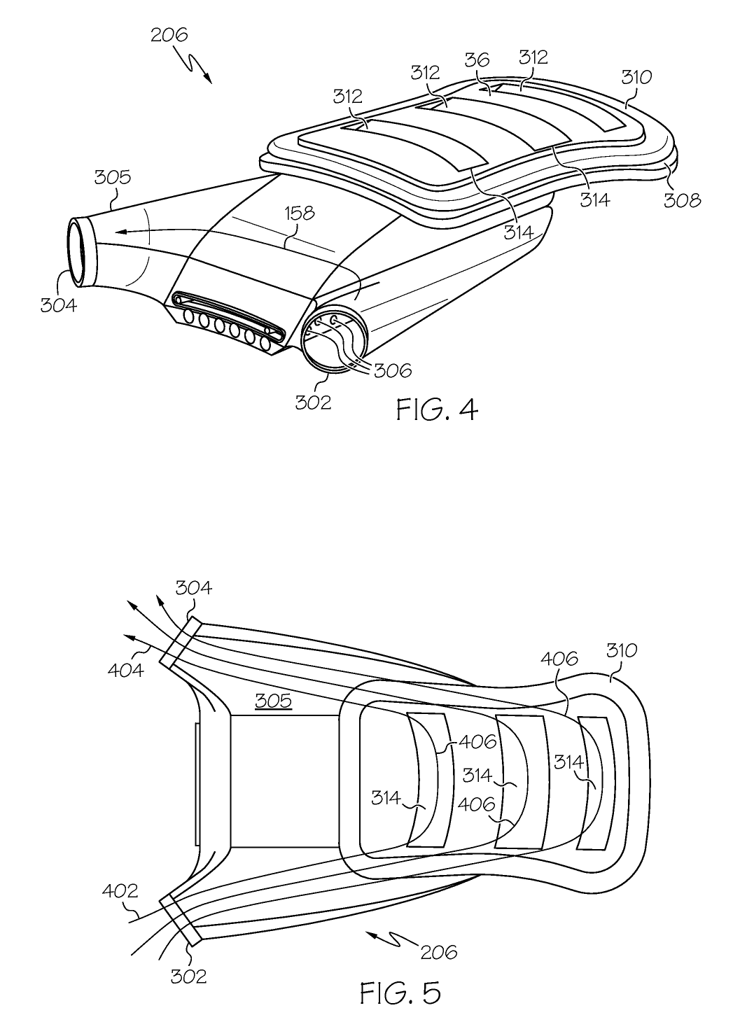

The precooler core (FIG. 4 305) of the precooler system 206 is configured to transfer heat between a first fluid flowing through the first flow passage 158 and a second fluid flowing through the second flow passage 312. Cool or cold bypass air (FIG. 3 202) from the bypass duct (FIG. 3 214) enters the precooler core (FIG. 4 305) at the bypass flow path inlet (FIG. 3 260) and hot engine air enters the precooler core (FIG. 4 305) at the engine air inlet 302. The cold and hot air are separately maintained in their respective flow paths by features within the precooler system 206. In an embodiment, the precooler system 206 employs features such as cross tubes and deflector slats to promote exchange of heat from the hot turbofan engine air with the relatively cold bypass air (FIG. 3 202) (cross tubes and deflector slats are described in connection with FIGS. 5-7). After heat exchange in the precooler system 206, the cooled turbofan engine air is released as discharge air at the engine air outlet 304 and may then be delivered to a target aircraft system, such as an air conditioning system, ECS (Environmental Control System) package, or an aircraft cabin.

FIG. 3 is a partial cross sectional view, above a turbofan engine centerline 105, of a turbofan engine 107 within nacelle 100, showing key features of a precooler system 206 in accordance with the exemplary embodiment. Bypass air 202 is shown flowing within bypass duct 214. Bypass duct 214 is bounded on one side by an inner surface 210 of nacelle 100 (defining an outer wall of the bypass duct 214) and on another side by an outer surface 212 of the turbofan engine 107, and extends axially through the nacelle 100. The inner surface 210 of the nacelle 100 is typically machined or manufactured to be smooth, free of blisters, pits, seams, or edges, machined to be a substantially continuous circumferential surface to minimize air obstruction within.

In the embodiment, precooler system 206 is disposed outside of the bypass duct 214 and mounted in an opening 216 in the nacelle 100. Ambient air 204 moves from the forward side 104 toward the aft side 102. Air in the bypass duct 302 is at a higher pressure that the ambient air 204. This makes it possible for cooling flow to pass through the pre-cooler releasing heated air from the second flow passage 312 into ambient air 204.

By disposing the precooler system 206 outside of the bypass duct 214, and integrally mounting the precooler system 206 into an opening 216 in the nacelle 100, in some embodiments, air may flow directly between the bypass duct 214 and the precooler system 206, without requiring any additional ducting. Additionally, the provided precooler system 206 design may coordinate with a HPSOV 150 and PRSOV 152 that are each located within the space between the turbofan engine 107 and the nacelle 100 (stage 155), further optimizing turbofan engine 107 space and weight.

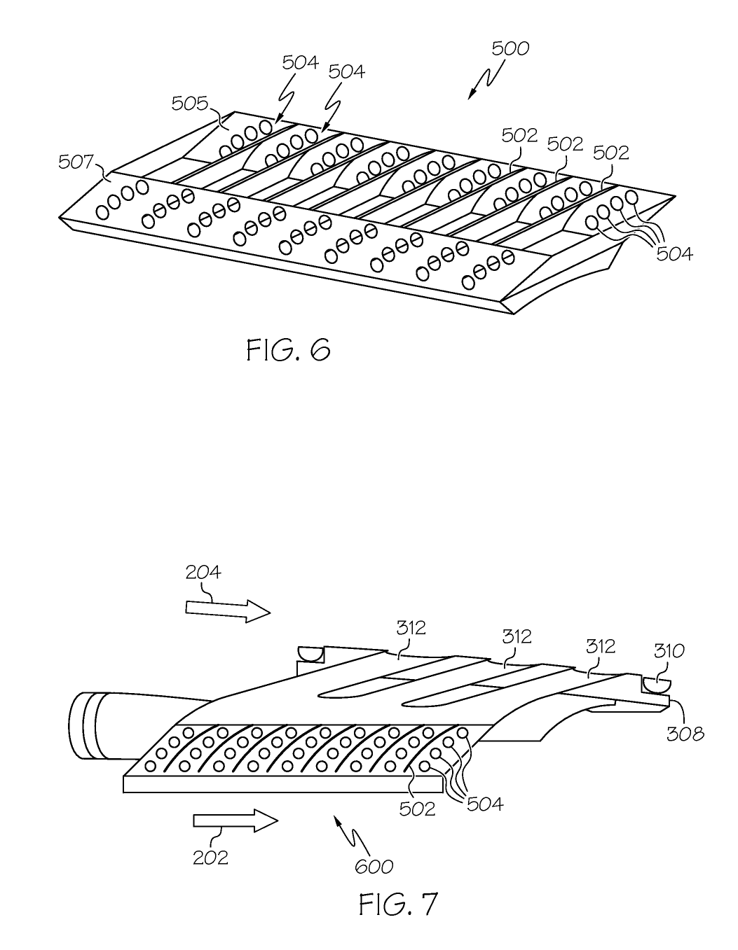

FIG. 4 is three dimensional image showing key features of a precooler system 206, in accordance with the exemplary embodiment. The precooler system 206 comprises a precooler core 305, having a first flow passage 158 between an engine air inlet 302 and an engine air outlet 304, the first flow passage 158 configured to be in flow communication with engine air at the engine air inlet 302 and discharge air at the engine air outlet 304. The precooler core 305 has one or more second flow passages 312 having bypass flow path inlet (not shown) and a bypass flow path outlet 314, and configured to be in flow communication with bypass air 202 at the bypass flow path inlet and ambient air at the bypass flow path outlet 314. Bypass flow path outlets 314 allow bypass air (FIG. 3 202) to pass through the precooler core 305. The precooler system 206 is configured to transfer heat between the air flowing in the first flow passage 158 and the air flowing in the second flow passage 312 (openings 306 are described in connection with FIG. 6). The first flow passage is described in connection with FIG. 5.

When mounted to the nacelle 100, the integrally mounted precooler system 206 provides a smooth outer surface 316 that is substantially continuous with the outer surface of nacelle 100. In an embodiment, precooler system 206 may comprise a plate 308, surrounded by a seal 310, the combination of which is configured to be integrally mounted into an appropriately sized opening 216 in nacelle 100, and forming a portion of the outer surface of the nacelle 100. In other embodiments, the precooler core 305 has a surface sufficient to be integrally mounted into an appropriately sized opening 216 in the nacelle 100 and provide a smooth outer surface 316 that is substantially continuous with the outer surface of nacelle 100.

FIG. 5 is an illustration of the precooler of FIG. 4 showing cross tubes 406 within the precooler core 305 of the precooler system 206. FIG. 5 is not to scale, but provides an intuitive visual depicting the cross tubes 406 extending through the first flow passage 158 and receiving hot engine air at the engine air inlet 302, channeling air through the precooler core, and releasing cooler discharge air at the engine air outlet 304. Concurrent with channeling hot engine air through the precooler core 305, cooler bypass air 202 is passing through one or more second flow passages 312, across one or more cross tubes 406 (by which it is being heated) in the second flow passages 312, and getting released into ambient air 204 outside of the nacelle 100. Bypass flow path outlets 314 provide a second flow passage 312 for the cooler bypass air 202 to cross the cross tubes 406 and cool the cross tubes 406 in doing so.

The arrangement of cross tubes 406, their dimensions, and their composition are selected to maximize heat exchanging surface area as the movement of air in the second flow passages 312 travels across them, cooling the cross tubes 406 as it does so. In the exemplary embodiment, the cross tubes 406 are stabilized within the precooler core 305 via a support structure. An exemplary support structure is described in connection with FIG. 6.

As may be readily appreciated, surface area is the key to effective heat transfer, and each additional cross tube 406 provides increased surface area for heat transfer. However, as surface area is increased, size, weight, and cost typically increase, forcing individual design applications to optimize the benefits of increased surface area with the tradeoffs. In an embodiment, the cross tubes 406 have a diameter from about ⅛ of an inch to about ¼ of an inch, and there are about ten cross tubes 406.

FIG. 6 is a three dimensional image of a support structure 500, in accordance with an exemplary embodiment. Support structure 500 is configured to fit within the precooler core 305 and is coupled therein. The support structure 500 may be used to define positions and locations of features implemented to assist in heat exchange.

For example, support structure 500 may be used to define an arrangement of cross tubes such that each cross tube 406 in the arrangement of cross tubes extends from the engine air inlet 302 to the engine air outlet 304. In the embodiment, support structure 500 comprises a first wall 505 and a second wall 507, each wall having a plurality of holes therethrough. The plurality of holes is arranged such that, when populated by cross tubes 406, the arrangement forms one or more air deflection paths to assist in heat exchange in the second flow passage 312. In the embodiment, the plurality of holes is arranged in groups 504 of holes, each of the groups 504 forming a slight arc in the same direction. In the embodiment each group 504 of holes includes four holes; however, the number of holes in the plurality of holes and the number of holes in each group 504 is design specific.

The support structure 500 may further comprise one or more deflector slats 502 coupled within the support structure 500 and oriented to deflect bypass air 202 and to assist in heat exchange through the second flow passage 312. Accordingly, in some embodiments, the support structure 500 may rely on an arrangement of the cross tubes 406 to deflect air, and in other embodiments, the support structure 500 may additionally rely on deflector slats 502 for deflecting air. Although the support structure 500 is shown as comprising a first wall 505 and a second wall 507, each wall having a plurality of holes therethrough, a variety of other configurations may be implemented to accomplish the same objective without straying from the scope of the invention.

FIG. 7 is a partial cross sectional view of a precooler system 206 showing the support structure 500 of FIG. 6 coupled within, in accordance with the exemplary embodiment. FIG. 7 provides additional detail of the second flow passages 312, the bypass air 202 and the ambient air 204.

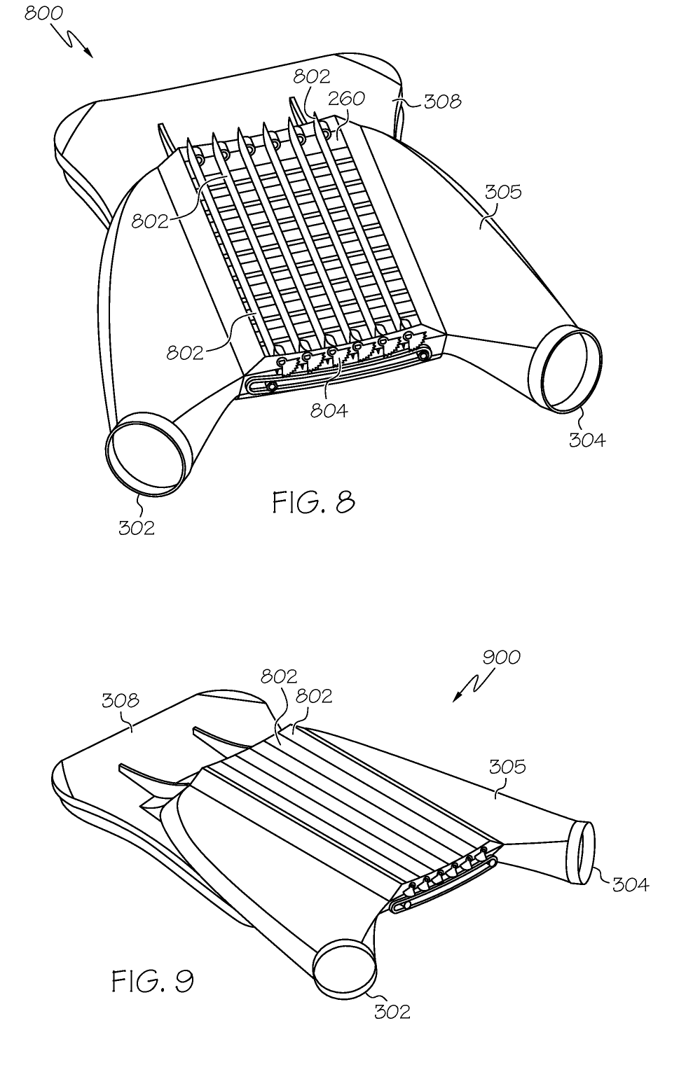

FIG. 8 and FIG. 9 are three dimensional images showing a precooler with a blocking assembly on the bypass flow path inlet, in accordance with an exemplary embodiment. The blocking assembly is coupled to the bypass flow path inlet 260 and configured to (i) permit bypass air 202 to flow through the second flow passage 312 when the blocking assembly is in a first position, and (ii) prevent bypass air 202 from flowing through the second flow passage 312, thereby forming a substantially continuous outer wall of the bypass duct 214 when the blocking assembly is a second position. The louvers may be self-sealing and act as the fan air valve FAV, thus simplifying the system level design.

As one with skill in the art will appreciate, the blocking functionality may be implemented in a variety of ways. In the embodiment, louvers 802 are each attached to the precooler core 305 with moveable fasteners 804. The size, material and dimension of the louvers 802 and moveable fasteners 804 are application specific. In FIG. 8, the louvers 802 are shown in a first position (open), permitting bypass air 202 to flow through the second flow passage 312, and in FIG. 9, louvers 802 are shown in a second position (closed), wherein the may self-seal and prevent bypass air 202 from flowing through the second flow passage 312, and form a substantially continuous outer wall of the bypass duct 214.

FIG. 10 and FIG. 11 are three dimensional images showing the precooler core 305 utilized in a right handed and in a left handed precooler system 206 applications, respectively, in accordance with an exemplary embodiment. Advantageously, the precooler system 206 is “non-handed,” in that it works in right handed and in left handed applications. In other words, although the location of the HPSOV 150, PRSOV 152, and flow of engine air was depicted and described as occurring in first direction in first flow passage 158 in connection with FIGS. 2, 4, and 5, the direction of flow of engine air can be reversed through the precooler core 305 without redesign of the precooler core 305. In practice, implementing a left handed precooler core (FIG. 10) and right handed precooler core (FIG. 11) only differs in the routing of the ducting (1002 and 1004, or 1102 and 1104, respectively) and placement of the respective valves. Advantageously, both implementations of the precooler system 206 work in coordination with the placement of the HPSOV 150 and PRSOV 152 at turbofan engine stage 155.

Thus, there has been provided a precooler system having a precooler core that is optimized to be integrally mounted to the turbofan engine, regardless of the turbofan engine size. The provided precooler system optimizes available space between a turbofan engine and the nacelle, and does not substantially increase weight and cost. The provided precooler system may be flexibly implemented as either a right handed precooler system or a left handed precooler system.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

Some of the embodiments and implementations are described above in terms of functional and/or logical block components or modules. However, it should be appreciated that such block components (or modules) may be realized by any number of hardware, software, and/or firmware components configured to perform the specified functions. To clearly illustrate this interchangeability of hardware and software, these illustrative components, blocks, modules, circuits, and steps have been described above generally in terms of their functionality. Skilled artisans may implement the described functionality in varying ways for each particular application, but such implementation decisions should not be interpreted as causing a departure from the scope of the present invention.

What is claimed is:

1. A precooler system, the precooler system comprising:
a nacelle;
a turbofan engine housed within the nacelle, the turbofan engine configured to discharge engine air and bypass air; the turbofan engine comprising a bypass duct providing a path for the bypass air;
a high pressure shut off valve (HPSOV) coupled to the turbofan engine;
a pressure regulating shut off valve (PRSOV) coupled to the turbofan engine and to the HPSOV; wherein the HPSOV and PRSOV are each (i) located within the same turbofan engine stage, and (ii) configured to cooperatively regulate pressure of engine air; and
a symmetrical precooler core disposed outside of the bypass duct, integrally mounted in an opening in the nacelle, and forming a substantially continuous outer wall of the bypass duct,
the symmetrical precooler core comprising (i) a first flow passage having an engine air inlet and an engine air outlet, the first flow passage being in flow communication with engine air at the engine air inlet and discharge air at the engine air outlet, and (ii) a second flow passage having bypass flow path inlet and a bypass flow path outlet and being in flow communication with bypass air at the bypass flow path inlet and ambient air at the bypass flow path outlet.

2. The precooler system of claim 1, further comprising a blocking assembly coupled to the bypass flow path inlet and configured to (i) prevent bypass air from flowing through the second flow passage, thereby self-sealing and forming a substantially continuous outer wall of the bypass duct when the blocking assembly is a first position, and (ii) permit bypass air to flow through the second flow passage when the blocking assembly is in a second position.

3. The precooler system of claim 2, wherein the blocking assembly comprises a plurality of substantially parallel louver doors extending across the second flow passage.

4. The precooler system of claim 3, further comprising:
a symmetrical support structure configured to fit within the symmetrical precooler core and coupled therein, the symmetrical support structure defining an arrangement of cross tubes, and wherein a first group of cross tubes is coupled to the symmetrical support structure.

5. The precooler system of claim 4, further comprising a plurality of cross tubes, and wherein the arrangement of cross tubes comprises a plurality of groups of cross tubes, the first group of cross tubes being one of the plurality of groups of cross tubes, and each group of cross tubes in the plurality of groups of cross tubes is arranged within the second flow passage to form a respective air deflection path between the bypass flow path inlet and the bypass flow path outlet.

6. A precooler system, the precooler system comprising:
a turbofan engine configured to discharge engine air and bypass air, the turbofan engine having a bypass duct associated therewith; and
a symmetrical precooler core configured to be integrally mounted in an opening in a nacelle, and disposed outside of the bypass duct, the symmetrical precooler core comprising
(i) a first flow passage having an engine air inlet and an engine air outlet, the first flow passage being in flow communication with the engine air at the engine air inlet and with discharge air at the engine air outlet, and
(ii) a second flow passage having bypass flow path inlet and a bypass flow path outlet and being in flow communication with bypass air at the bypass flow path inlet and ambient air at the bypass flow path outlet, the symmetrical precooler core further configured to transfer heat between the first flow passage and the second flow passage.

7. The precooler system of claim 6, further comprising a blocking assembly coupled to the bypass flow path inlet and configured to (i) prevent bypass air from flowing through the second flow passage, thereby self-sealing and forming a substantially continuous outer wall of the bypass duct when the blocking assembly is a first position, and (ii) permit bypass air to flow through the second flow passage when the blocking assembly is in a second position.

8. The precooler system of claim 7, wherein the blocking assembly comprises a plurality of substantially parallel louver doors extending across the second flow passage.

9. The precooler system of claim 8, further comprising
a first cross tube extending through the first flow passage, the first cross tube receiving engine air at the engine air inlet and releasing discharge air at the engine air outlet.
wherein the first cross tube is one of a first group of cross tubes, and the first group of cross tubes is arranged within the second flow passage to form an air deflection path between the bypass flow path inlet and the bypass flow path outlet.

10. The precooler system of claim 9, further comprising:
a support structure configured to fit within the precooler core and coupled therein, the support structure defining an arrangement of cross tubes such that each cross tube in the arrangement of cross tubes extends from the engine air inlet to the engine air outlet; and
wherein the first group of cross tubes is coupled to the support structure.

11. The precooler system of claim 10, wherein the arrangement of cross tubes comprises a plurality of groups of cross tubes, the first group of cross tubes being one of the plurality of groups of cross tubes, and each group of cross tubes in the plurality of groups of cross tubes is arranged within the second flow passage to form a respective air deflection path between the bypass flow path inlet and the bypass flow path outlet.

12. The precooler system of claim 11, further comprising a deflector slat coupled within the support structure and oriented to direct bypass air through the second flow passage.

13. The precooler system of claim 11, further comprising a plurality of deflector slats each of which being coupled within the support structure and oriented to direct bypass air through the second flow passage.

14. The precooler system of claim 7, wherein the turbofan engine further comprises a high pressure shut off valve (HPSOV) and a pressure regulating shut off valve (PRSOV), the HPSOV and PRSOV each being coupled to the turbofan engine and each being located at substantially a same turbofan engine stage, and wherein the HPSOV and PRSOV are configured to cooperatively regulate pressure of the engine air.

15. A symmetrical precooler core, the symmetrical precooler core comprising:
a first flow passage having an engine air inlet and an engine air outlet, the first flow passage configured to be in flow communication with engine air at the engine air inlet and with discharge air at the engine air outlet; and
a second flow passage having bypass flow path inlet and a bypass flow path outlet and configured to be in flow communication with bypass air at the bypass flow path inlet and with ambient air at the bypass flow path outlet; and
wherein the symmetrical precooler core is configured to (i) be disposed outside of a turbofan engine bypass duct, (ii) be integrally mounted in an opening in a nacelle, (iii) form a substantially continuous outer wall of the bypass duct.

16. The precooler core of claim 15, further comprising a first group of cross tubes, and the first group of cross tubes is arranged within the second flow passage to form an air deflection path in the second flow passage.

17. The precooler core of claim 16, wherein the arrangement of cross tubes comprises a plurality of groups of cross tubes, the first group of cross tubes is one of the plurality of groups of cross tubes, and each group of cross tubes in the plurality of groups of cross tubes is arranged within the second flow passage to form a respective air deflection path between the bypass flow path inlet and the bypass flow path outlet.

18. The precooler core of claim 17, further comprising a deflector slat coupled within the support structure and oriented to deflect bypass air through the second flow passage.

19. The precooler core of claim 17, further comprising a plurality of deflector slats each of which being coupled within the support structure and oriented to deflect bypass air through the second flow passage.

20. The precooler core of claim 15, further comprising a blocking assembly coupled to the bypass flow path inlet and configured to (i) self-seal and prevent bypass air from flowing through the second flow passage, thereby forming a substantially continuous outer wall of the bypass duct when the blocking assembly is a first position, and (ii) permit bypass air to flow through the second flow passage when the blocking assembly is in a second position.
